(19) United States
(12) Patent Application Publication
(10) Pub. No.: US 2025/0277658 A1
(43) Pub. Date: Sep. 4, 2025

(54) Chromatic confocal high-speed measuring method and scalable device for implementing the method

(71) Applicant: Confokal LLC, Charlottesville, VA (US)

(72) Inventor: Marius Christian Jurca, Bruchkoebel (DE)

(21) Appl. No.: 19/067,304

(22) Filed: Feb. 28, 2025

(30) Foreign Application Priority Data
Mar. 4, 2024 (DE) 10 2024 106 211.8

(51) Int. Cl. G01B 11/02

(52) U.S. Cl. CPC G01B 11/026; G01B 2210/50

(57) ABSTRACT

An extremely fast optical measurement method combines a chromatic confocal distance measurement with a chromatic confocal color measurement of a partially reflective object surface. A corresponding measuring device uses at least two monochromatic emitters, in particular single- or multi-mode laser diodes, as the light source.

### REFERENCE TO RELATED APPLICATIONS

The current application claims the benefit of German Patent Application No. 10 2024 106 211.8, filed on Mar. 4, 2024, which is hereby incorporated by reference.

### FIELD OF THE DISCLOSURE

The invention relates to a method and a size-scalable device for extremely fast, non-contact measurement of physical properties of an at least partially reflective optical boundary surface of an object, in particular for the point-measurement of distance and color, in order to create topographical maps of the object surface in the case of moving objects or monitor changes in correlative comparison to a previously stored reference.

### RELATED ART

The basic measuring principle of the invention presented here, both in the field of distance measurement and in the field of simultaneous color detection, is that of chromatic confocal microscopy, whereby an innovation here is that significant system advantages have been gained from the use of system components that would otherwise be completely unsuitable for the previously known standard implementations of the chromatic confocal measuring principle.

The first approaches have already been presented in U.S. Pat. No. 3,013,467A (1961, M. Minsky) and in “FOCUS-WAVELENGTH ENCODED OPTICAL PROFILOMETER” by G. Molesini et al. (OPTICS COMMUNICATIONS, Volume 49, Number 4, 1984). The first modern, industrially available distance measuring devices based on this measuring principle were known from FR2738343A1 (1995, Joseph Cohen Sabban) and from the article by M. Jurca et al. (1997, Sensormagazin No. 4/97, p. 15-18, “Eine Alternative zum Laser”).

In the meantime, many process variants have been developed, which cannot be mentioned here in full, although the physically necessary features resulting from the rigorous implementation of the chromatic confocal measuring principle are summarized below.

Such a point-distance measuring device consists of:
a) A polychromatic, incoherent light source,
b) A lens that exhibits increased axial chromatic aberration, known in the technical literature as a “chromatic lens” or “hyperchromatic lens”,
c) A very small aperture, usually round, for the implementation of the confocal measuring arrangement, which lets through both the polychromatic light from the light source i) in the direction of the objective and the measuring point on the object surface, and ii) the resulting back-reflection from the object surface in the measuring point in the opposite direction,
d) A device for separating the back-reflection from the polychromatic light of the light source,
e) A spectral-resolving light intensity measuring device for analyzing the back-reflection, wherein the spectral-resolving light intensity measuring device separately measures each of the monochromatic wavelengths used; in particular, it may comprise a low-noise photodiode, coupled either directly or via an optical fiber, for detecting each of the monochromatic wavelengths used.

The polychromatic light (a) is focused through the aperture (c) by the chromatic objective (b) in such a way that all individual wavelengths of the polychromatic light are distributed linearly on the optical axis of the objective between the focal length Z_{B} (for the shortest wavelength of the polychromatic light) and the focal length Z_{R} (>Z_{B}) (for the longest wavelength of the polychromatic light) according to the longitudinal chromatic aberration of the objective. “B” stands for blue and “R” for red. If the focused polychromatic light lies on an optical boundary surface at a distance Z_{OBJ} (Z_{B}<Z_{OBJ}<Z_{R}), a back-reflection from the focal point occurs with the wavelength λ_{OBJ}, and essentially only with this wavelength λ_{B}<λ_{OBJ}<λ_{R}, the reflected light passes back through the lens and through the (point-shaped) aperture that is conjugated with the object focal point and is then separated by the device (d) and fed to the measuring device (e). The small aperture (c) functions like a spatial filter that only allows the light that is backscattered from the object to pass through from the immediate axial and lateral surroundings of Z_{OBJ}. All other light is spatially filtered out by the receiving aperture—this results in the high measurement resolution of the method.

The facts presented have a whole series of compelling consequences, e.g., the measurable intensity of the back-reflection depends on the convolution of the diffraction integral of the aperture with the point-spread-function (PSF) of the objective, which in turn depends mainly on the numerical aperture (“NA”) of the objective, so that there is an understandable desire to have the highest possible NA, as this leads to an improvement in the achievable measurement resolution. For the same reason, the diameter of the aperture is kept small. The chromatic objective also usually has four to six lenses in order to produce the smallest possible focal point, free of spherical aberrations. The following variants of the chromatic lens are known:
b1. Multi-lens hyperchromat that focusses the aperture directly on the object,
b2. Combination of a collimating lens (achromat) with a multi-lens hyperchromat,
b3. Use of a single Fresnel lens as a hyperchromat (similar to b1),
b4. Use of a lens combination with a Fresnel lens (similar to b2),
b5. Use of a gradient index lens (similar to b1),
b6. Use of a lens combination with a gradient index lens (similar to b2).

The variants b3 to b6 usually lead to larger focal point diameters in comparable arrangements.

Furthermore, it is understandable that the light source cannot be monochromatic, or consisting of several monochromatic sources, because each monochromatic source would focus from the lens into a single point and it would not be possible to measure the distance between two neighboring such points because the back-reflections in traditional chromatic confocal set-ups do not overlap.

Several variants are known as polychromatic light sources:
a1. Halogen lamp,
a2. High-pressure lamp,
a3. Light-emitting diodes (“LEDs”) or super-luminescent-emitting diodes (“SLEDs”),
a4. Laser-generated continuum spectrum.

The incoherent light of the polychromatic light source is one of the main reasons for the many limitations of the method, in particular the measurement speed, the maximum available light output and the resulting limited signal-to-noise ratio (SNR) value.

The separating device of the back-reflection is mainly offered in two variants:
d1. As “Y”- or “X”-shaped splice coupler with gradient-index (GRIN) optical fibers (GIFO),
d2. With optical macro components such as beam splitters or beam splitter cubes, filters, pinhole apertures etc.

The measuring device is usually an optical spectrometer, whereby the wavelength-related position of the back-reflection is determined using a charge-coupled device (“CCD”) line. In most cases, this also represents the factor that limits measurement speed.

DE 10 2008 029 459 B4 and WO 2009153067 A2 (2008, M. Jurca) describe a replacement of the spectral measuring device (d) in the form of a single photodiode and the associated use of two alternately switched-on LEDs as a polychromatic light source, whereby the radiation spectra of the two LEDs partially overlap. By eliminating the optical spectrometer, the method presented is very simple and, above all, much faster (several orders of magnitude).

All known measurement methods and devices which directly, without a relative movement between the measurement device and the object being measured during a measurement process, have an imaging output of the measurement data as their objective, or those that require a Fourier-like processing of the measurement data due to the interferometer structure of the measurement device, were not considered here because they do not compete with the present invention. Likewise, no laser measurement methods were considered that are not based on the chromatic confocal measurement principle.

DE 10 2004 022 454 A1 describes an optical measuring device for measuring the shape or roughness of a workpiece, for which a difference signal from two photoreceivers assigned to different focal points is evaluated. DE 10 2006 026 775 A1 discloses a device with several LEDs as a polychromatic light source for illuminating a surface to be examined via an optical fiber and a focusing element, whereby reflected light passes via the focusing element and the optical fiber to a beam splitter, which directs the light to be detected to a detector unit via a dispersion element. DE 20 2019 103 527 U1 describes an optical measuring device with a confocal-chromatic optical sensor. U.S. Pat. No. 5,785,651 A discloses a confocal measuring microscope, whereby several lasers are used as a polychromatic light source and a suitable chromatic lens is used for this purpose.

### SUMMARY OF THE DISCLOSURE

The objective of the invention is to provide a method and a device for the fastest possible simultaneous non-contact measurement of the distance to and color of a partially reflective optical boundary surface, which are capable of modifying the chromatic confocal measurement principle of the distance to a point on the surface being measured in such a way that the use of several monochromatic light sources instead of the otherwise required polychromatic light sources is possible, so that much better signal-to-noise ratios can be achieved at considerably higher measuring speeds than with the known methods due to the much higher available and usable light output, and whereby the devices for carrying out the method are (almost) arbitrarily scalable and at the same time enable the detection of the color of the object being measured.

The problem is solved by the objectives of the independent claims.

A method according to the invention, which solves the aforementioned problem, has the following steps:
a) Generation of multi-spectral light (110), consisting of two or more pulsed or continuously powered monochromatic light sources (101a, b, c), for example three (e.g., red-green-blue (“RGB”) laser diode module), with emission wavelengths 40-120 nm apart, which are regulated in terms of power and temperature in such a way that the ratios of the powers of the monochromatic light sources are actively kept constant (via feedback alternative 1 (module 200), alternative 2 (300) or alternative 3 (400)),
b) Coupling of the light (110) into an arm of a 2:1—Y-fiber coupler (30) via an opto-mechanical plug device (107 and 36), wherein the optical fiber (32) is designed both as a grad-index (“GRIN”) or preferably step-index (“STIN”) multimode fiber or multimode circulator, and preferably has a relatively large core diameter of 50-200 μm, which is in strong contradiction (both above-mentioned facts) to the already known devices, wherein the common output fiber is coupled into the chromatic measurement objective #1 (800) via an FC/APC fiber plug (35 and 803) (where “FC/APC” means a fiber connector with an Angled Physical Contact to increase the return loss),
c) Focusing the multi-spectral light via the chromatic measuring objective #1 (800) with small NA, preferably 0.03 to 0.15, via a simple combination of optical components (801), preferably two coaxial and spatially separated (801a, b), which together have an enlarged longitudinal chromatic aberration, (which is in contradiction to the already known devices, since such an objective usually has the largest possible NA and requires five to six lenses for the enlarged longitudinal chromatic aberration,) so that the smallest possible foci of the individual monochromatic light sources lie at different distances on the optical axis of the objective (between the focal planes 11 and 12, after the beam deflection by the beam splitter (15), whereby the back-reflection from an object surface (focal plane 10), which lies between the foci of the smallest and the largest monochromatic light source used, can be detected back via the objective and the Y-fiber coupler on its second arm (33) with the measuring module (500), wherein the design of the objective in connection with the Y-fiber coupler ensures that, despite the large wavelength distance between two neighboring monochromatic light sources, the Bessel function-like axial, monochromatic back-reflections (referred to here as “bell curves”) partially overlap in terms of measured power,
d) deflecting the focused measurement beam from the chromatic objective #1 (800), preferably by 90°, onto the object surface to be measured by means of a slightly wedge-shaped, anti-reflective coated beam splitter (15), which has a reflection/transmission ratio of at least 50% or more, so that a corresponding part of the light reflected from the object passes through the beam splitter into a second, identical chromatic unit of optical components (601), such as that of the objective #1 (801) of step c), which joins the monochromatic components of the back-reflection together again in a collimated beam and brings the chromatic components of the beam into coincidence (604), so that the distance information is lost due to the omission of an aperture and instead the ratios of the measurable monochromatic reflected powers contain the color information of the object surface and are measured with the color measuring device (606), whereby the special chromatic beam routing in the region of the object surface also enables improved detection of partially translucent object surfaces,
e) Fast, spectrally selective (via a holographic grating (504)), highly dynamic detection of the monochromatic components of the back-reflection measured at the second arm of the Y-fiber coupler (33) with selected individual low-noise photodiodes (509a, b, c), which have sufficient sensitivity and response speed in the wavelength range of the monochromatic light sources used,
f) Calculate the measuring distance from the spectrally selectively measured powers of the monochromatic back-reflection components from step e),
g) Fast, spectrally selective, highly dynamic detection of the monochromatic components of the back-reflection measured coaxially behind the second chromatic combination of optical components (606), and
h) Calculation of the color information from the spectrally selectively measured powers of the monochromatic back-reflection components from step d), whereby the simultaneously obtained distance information is also used to evaluate the color information.

To avoid reflections and/or etalon effects (interference effects between parallel surfaces of an optical component), the beam splitter can be designed as a wedge-shaped beam splitter, in particular with a wedge angle of 0.5°.

A sensor or device according to the invention is set up to carry out the method according to the invention and contains the components mentioned for the method. Optionally, the sensor/device is set up to carry out the method variants described above.

In a distance measurement method according to the invention based on the principle of chromatic confocal distance measurement, a polychromatic light source is used, which consists of several single-mode or multi-mode, pulsed or continuously powered laser diodes. The light thus obtained is focused into a multi-mode “Y”- or “X”-shaped fiber coupler, which has a fiber core diameter greater than 50 μm. An output fiber of the fiber coupler is introduced into a hyperchromatic lens via an FC/APC fiber connector of 8° to increase the return loss. The hyperchromatic objective consists of a collimating achromat and a hyperchromatic combination of preferably only two optical components (in particular a refractive lens and a diffractive lens/Fresnel lens), which together form a “chromatic objective” with a small NA. For a sufficient overlap of the back-reflection bell curves, NA is ≤0.3. The ratio of the longitudinal aberration and the focal length of the hyperchromatic combination is between 0.15 and 0.5 and the longitudinal aberration of the hyperchromatic combination covers the wavelength range of the light used. A resulting back-reflection passes from an optical (at least) partially reflective surface of the object being measured, which is usually also referred to as the “optical refractive index interface” and lies approximately perpendicular to the optical axis between the foci of the shortest and longest laser diode wavelengths used, back into the fiber coupler via the chromatic objective and is fed to a spectral-resolving, light power measuring device via a measurement output fiber of the fiber coupler. A single low-noise photodiode is used to detect each of the monochromatic wavelengths used. Low-noise photodiodes can be understood to be so-called Si (silicon) “PIN” photodiodes or photodiodes with a noise-equivalent radiant power noise-equivalent power (“NEP”) of

$$NEP < 5 \times {10}^{- 14} [ \frac{W}{\sqrt{H z}} ] .$$

The aforementioned fiber coupler is preferably designed as a multi-mode circulator (“MM circulator”). An MM circulator is a “Y” fiber coupler with better separation of the transmitted and received power, so that the disturbing back-reflection from inside of the coupler, usually called “optical noise”, is minimized. Such fiber components are known from the single-mode fiber sector and have only recently become available for STIN fiber. There are also no known chromatic confocal microscopy (“CCM”) methods that use a STIN fiber circulator.

The specification of an “approximately perpendicular” measurement object surface relates to the necessity that the normal on the object surface must just be covered by the optical aperture (˜diameter of the last objective lens). Thus, for a measurement on a reflective surface, the maximum tilt of the object surface at the measuring point relative to the optical axis of the lens will only be 90°±arc tan(NA) (e.g., for NA=0.1=>90°±5.74°). If the object surface is rather scattering, the measurement can also be carried out at larger tilts, as sufficient scattered light is captured by the lens. This “approximately perpendicular” limit is directly dependent on the NA of the lens.

Optional variants of the method according to the invention and the sensor/device according to the invention are explained in the dependent claims and the following description. Further variants of the method result from the intended use of the device described. Conversely, the device/sensor can be set up to carry out the method processes described. In particular, an electronic control device can be provided for this purpose, which is set up to control the described light sources and detectors/measuring devices and to process and analyze signals in order to implement the described processes.

### BRIEF DESCRIPTION OF THE DRAWINGS

Further effects and features of the invention are described below with reference to the accompanying schematic figures:

FIG. 1: Monochromatic back-reflections obtained via a standard CCM objective of high NA (five lenses, NA=0.45) do not overlap and therefore cannot be analyzed with the new measurement method.

FIG. 2: Monochromatic back-reflections obtained via a CCM objective of low NA (two lenses, NA=0.11), according to the new measurement method, overlap even at 70 nm distance or 114 nm distance of the RGB wavelengths shown here as an example.

FIG. 3A: Schematic overview of a sensor, according to the invention, comprising the distance sensor “sensor D” (800), color sensor “sensor F” (600), beam splitter (15) and signal evaluation “sensor P”, with this designation as the overall term for all components of the signal recording and evaluation (such as the assemblies 100, 200, 300, 400, 500 and their alternative designs).

FIG. 3B: Schematic detailed overview of the light source (100) of a sensor according to the invention, shown as an RGB light source as an example together with “Alternative 1” of the reference measurement of the light source (200) used as active feedback and control of the light source.

FIG. 4: Optimally selected laser wavelengths generate bell curves with the new measurement method, which ideally overlap at approximately 50% of the maximum amplitude.

FIG. 5: The limiting case of selecting two neighboring laser wavelengths exists according to the new measurement method if the resulting bell curves overlap at 1/e² (=135.34 based on the scaled value of the amplitude=1000 arbitrary units (“a.u.”)) of the maximum amplitude.

FIG. 6: Sketch of the vector addition to illustrate the nomenclature used.

FIG. 7: Typical right-skewed bell curves showing scaled z-axis-related back-reflection intensity curves as a function of their wavelengths; focal distances (FD) FD1<FD2< . . . <FD8 correspond to the wavelengths λ1<λ2< . . . <λ8.

FIG. 8: The result of the claimed formula

$$WP ( x ) = {W}_{Σ} ( z ) = arctan \frac{{y}_{Σ}}{{x}_{Σ}} \qquad ( x )$$

for determining the sensor characteristic curve based on the signals in FIG. 7, where FDᵢ indicates the Z-position of the individual foci.

FIG. 9: Using the “contrast function” [r(x)] increases the measurement resolution locally, but reduces the practically the processable measurement range.

FIG. 10: The pairwise subtraction of the closely neighboring bell curves with subsequent normalization shows that the slope of the resulting characteristic curves is largely independent of the wavelength spacing of the corresponding laser wavelengths, although with decreasing wavelength spacing—due to the near cancellation of the bell curves involved—the signal amplitude becomes too low for subsequent signal processing.

FIG. 11: The pairwise subtraction of the neighboring bell curves, without subsequent normalization, shows the amplitude of the resulting characteristic curves f2(x)−f1(x) for λ2−λ1=45 nm and f4(x)−f3(x) for λ4−λ3=5 nm, where x=measuring distance axis.

FIG. 12: The graphical overlay of the bell curves of λ1 (around FD1) and λ2 (around FD2), as dashed lines and logarithmic as full lines (scaled to approx. 1000 a.u.), shows that logarithmizing shifts the intersection point of the bell curves at approx. 80% I₀ instead of approx. 50% I₀ for the linear measurement data, apparently advantageously.

FIG. 13: The steepest characteristic curves with the highest possible measurement resolution are achieved with the differential measurement of two neighboring linearly recorded bell curves; all other evaluation methods are less steep in the linear median range.

FIG. 14A left: Use of a fiber-coupled spectral-resolving measurement module (610) and 14B right: use of a 2D color measurement point array or a CCD camera (608); the option of a module 614 for measuring the reflectivity of the object surface is also shown schematically, whereby this module can also be added to the image on the left.

FIG. 15: CIE “color triangle”=“shoe sole diagram” with exemplary data

$${λ}_{1} = 450 nm , {λ}_{2} = 520 nm , {λ}_{3} = 634 nm \text{=>} {β}_{1} = 0 ° , {β}_{2} = 126 ° , {β}_{3} = 248 °$$

CIE (color standard 1931 from “Commission Internationale de l′Éclairage”).

FIG. 16: Positioning of the color vectors from the example in FIG. 15, as well as the resulting vector [symbol] in the xy plane.

FIG. 17: Schematic construction of the resulting color index, i.e. the color measurement result F_{RΣ}(z) as a function of the measured reflectivity R(z). The angle α results from the vector addition, as the angles of the “color vectors” are predetermined by FIG. 15 and the respective wavelength. The more wavelengths, the more accurate the color information will be. The calibration of the color measurement will also result in a conversion table for other color information formats.

FIG. 18: Schematic sectional drawing of the telecentric circular scanner (50); top view of the focal point path on the object surface “RKS” (55). Apex angle “A” (61) of the round wedge-shaped prisms (51, 52); axial distance “H” (60) of the wedge-shaped prisms (51, 52).

FIG. 19: Schematic sectional drawing of the telecentric line scanner (70); focal point path on the object surface with the length “L” (76), angle of rotation “W” (73) of the cube-shaped prism (71).

### DETAILED DESCRIPTION OF EXAMPLE EMBODIMENTS

Various embodiments are described below with reference to the figures. Identical and identically acting components are generally labelled with the same reference signs.

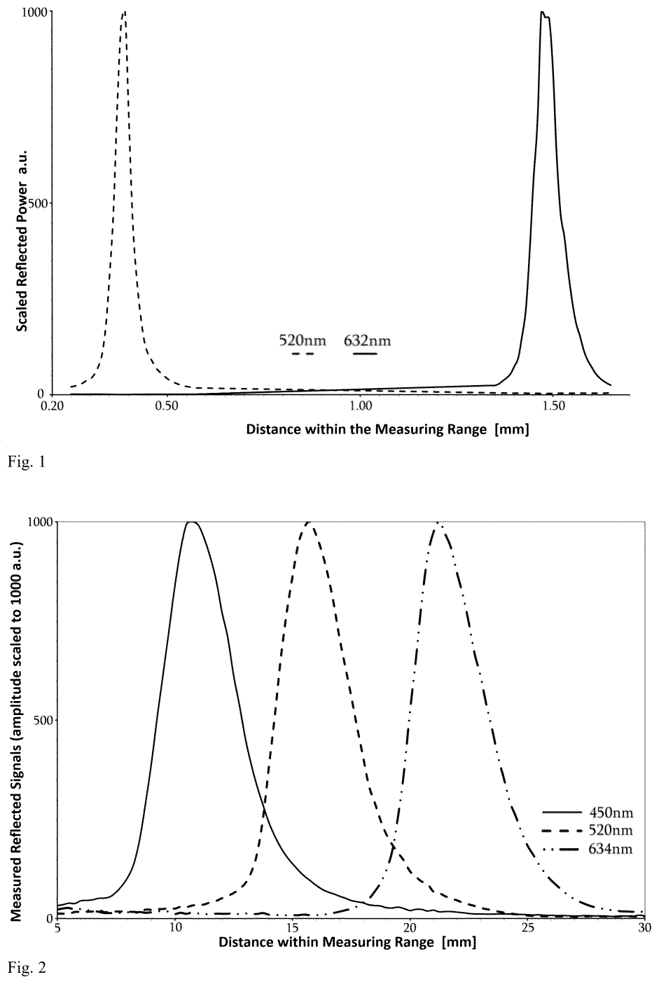

FIGS. 1 and 2 illustrate, with measured signals, the difference in the back-reflection curve in the case of a desirable Hi-NA lens according to the State-of-the-Art (“SoA”) technology (FIG. 1) and in the case of the lens with small NA claimed here (FIG. 2), if laser diodes are used as light sources according to the present invention. The use of a “perfectly” designed lens to implement the SoA CCM method together with otherwise unsuitable monochromatic light sources, which are essential for the new method, leads to very narrow back-reflections that are far apart, do not overlap and therefore could not be analyzed with the new measurement method. The better the lens, in terms of diffraction-limited imaging, the narrower the back-reflections.

In FIGS. 1 and 2, the abscissa indicates the distance of an object surface from the (chromatic) lens. Illumination light is focused by the chromatic objective at a specific distance depending on the wavelength of the light. Depending on the measurement situation, an object surface to be examined may be within or outside of the focal planes of the illumination wavelengths. Light reflected from the object surface can reach a light power measuring device via the chromatic lens. The higher the NA of the lens used, the smaller the distance range for which light from a monochromatic light source leads to measurable back-reflections. The ordinate in FIGS. 1 and 2 indicates the measurable light output of back-reflections (scaled to an arbitrary value). With the high NA lens in FIG. 1, an illumination wavelength only leads to a narrow distance range in which an object surface produces a measurable back-reflection. The back-reflection therefore has a narrow bell curve shape and the back-reflections of different illumination wavelengths (520 nm and 632 nm in FIG. 1) do not overlap. It is not possible to make a statement about the distance to an object in FIG. 1 for the distance range between the two non-overlapping bell curves. In contrast, a chromatic objective with a smaller NA is used in FIG. 2, whereby monochromatic illumination light leads to a back-reflection with a wider bell shape. In addition, the bell curves of the back-reflections overlap with the illumination wavelengths used. This creates a continuous distance measurement range. In FIG. 2, this measuring range essentially extends from the distance at which the back-reflection of the smallest illumination wavelength used can be measured to the distance at which the back-reflection of the largest illumination wavelength used can be measured. In FIG. 1, on the other hand, a usable measurement range is interrupted due to the lack of overlapping back-reflection bell curves and is limited to the narrow widths of the bell curves. The ratio

$$\frac{usable measuring range}{focal length of shortest wavelength}$$

in FIG. 1 is just 0.0314 for a wavelength spacing between λ₂ (full line) and λ₁ (dashed line) of 112 nm.

In direct comparison, FIG. 2 shows an example of the course of the back-reflections with the measuring distance (x) measured with the objective of the invention, whereby there is a comparable wavelength distance (to that of FIG. 1) of 114 nm between the back-reflection with λ₃ (dash-two-dot line) and λ₂ (dashed line). The ratio

$$\frac{usable measuring range}{focal length of shortest wavelength}$$

is approx. 0.4, whereas only approx. 0.12 is used in practice in FIG. 2.

For a conventional “good measuring device” according to the SoA chromatic confocal measuring principle, it is imperative to use an objective with the highest possible NA value, which is achieved by using many lenses in order to reduce all other aberrations and to linearize and increase the longitudinal chromatic aberration as much as possible, and it is in no way possible to use laser diodes as a light source in such devices for two reasons: i) the back-reflections are narrow non-overlapping spikes, so nothing can be measured in between (see FIG. 1), and ii) the use of laser diodes (coherent, monochromatic light) in a conventional device leads to interference for various reasons in both the measurement system and the reflected signal from the object surface, provided it is not a mirror. As a result, it is not thought in the direction of the present invention to develop a chromatic confocal measuring device.

FIG. 2 shows that, according to the invention, the back-reflection curves are overlapping, “smooth”, monotonically increasing and decreasing. By overlapping the back-reflection bell curves for two wavelengths used, an object distance can be calculated particularly precisely from the ratio of the measured back-reflection intensities for different wavelengths. If, on the other hand, the bell curves do not overlap, see FIG. 1, then, simply put, only as many discrete distance values could be determined as the illumination wavelengths used.

Interference effects, as explained above, would create an irregular structure on the edges of the curves, which would also be unstable in time—there would also be many intermediate maxima, making it impossible to calculate the distance using the new method. As a rule, as soon as lasers are involved, they are used as distance meters in interferometer devices, triangulation devices or devices based on the time-of-flight measurement principle. Such methods and devices are not discussed here, as they are not in competition with the present invention.

### Overview of the Sensor

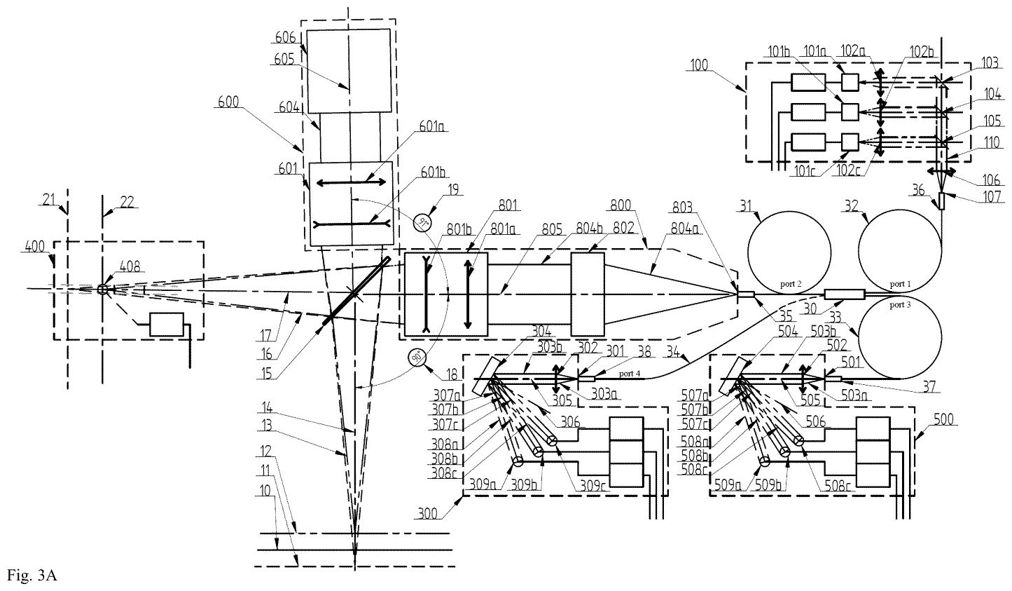

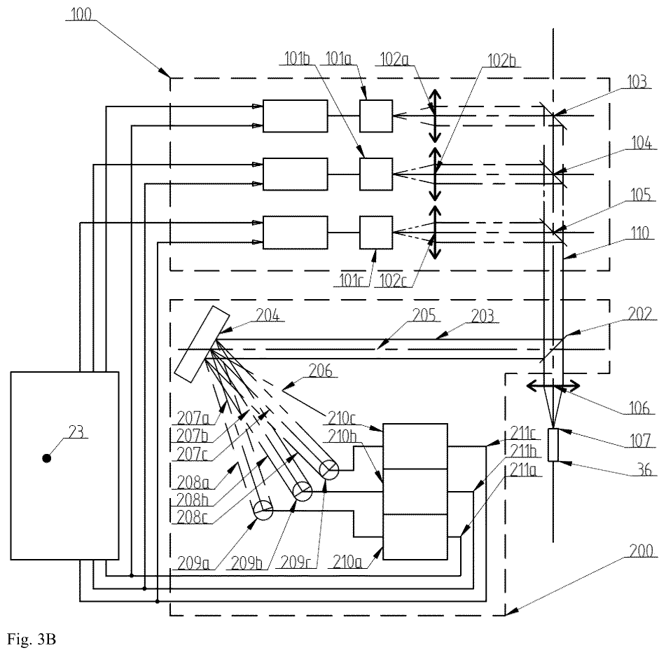

FIG. 3A together with the detailed sketch from FIG. 3B represent a sketch of an entire sensor according to an embodiment of the invention, comprising a light source (100), a distance measuring lens (800), a color measuring device (600), an “X-” or “Y-” shaped optical fiber coupler (30), a spectral-resolving back-reflection measuring device (500), a spectral-resolving measuring device for detecting the emission of the light source (200, shown in FIG. 3B) or 300 or 400) for the purpose of feedback and control of the output emission of the light source, a beam splitter (15), as well as the measuring arrangement represented by the object surface (10) and its boundary positions (11 and 12) and indicated by the illustrated beam paths (13 and possibly 16).

Laser diodes (101a, b, c) are preferably used as light sources in the new measurement method, although they have many stability problems, as explained below.

Laser diodes are thermally very unstable, react very sensitively to operating current fluctuations and are subject to some long-term changes in the technical specification. Therefore, according to the invention, the wavelength and the power of each laser diode used are selected very precisely and, above all, free of any possible superimposition of the emission characteristics with back-reflections from the measuring system or from the measuring area. The laser diodes usually contain a photodiode precisely for this purpose, e.g., for controlling the output power, but such photodiodes are not suitable for use in the present invention for two reasons:
a) Usually, the quality of these photodiodes is not sufficient for the purpose described, as they are produced in the same manufacturing process as the laser diode for cost reasons, so that they only offer a compromise solution for physical reasons,
b) Back-reflections from the measurement object usually return and influence the operating point of the laser diode accordingly—which is not permitted in the present invention.

This problem is taken into account in the new measuring method by proposing three different ways of measuring the light source emission as alternative solutions 200 (FIG. 3B), or 300 (FIG. 3A), or 400 (FIG. 3A).

In detail, the emissions of three laser diodes (101a, b, c) are collimated via the optical components (102a, b, c), dichroically added via the beam splitters (103, 104, 105) and focused via (106) into the “Port 1” (32) fiber connector (107). The light emission from the light source 100 enters the fiber connector (35) and (803) via “Port 2” (31), so that the light (804a) is collimated (804b) in the objective (800) via the achromatic lens (802) and focused onto the object surface (10) via the hyperchromatic lens combination (801) (consisting of 801a and 801b), whereby the focused radiation (13) is deflected by preferably 90° with the beam splitter (15). The optical axis (805) of the lens (800) is preferably perpendicular to the optical axis (15) of the focused measuring radiation (13). The areas (11) and (12) schematically represent the limits of the measuring range.

The light that is backscattered or partially reflected by the surface of the object being measured (10) passes backwards via the beam splitter (15) and the lens (800) into the fiber connector (35), so that the light passes via the fiber “port 3” (33) via the fiber connector (37/501) into the spectral-resolving measurement unit (500). Here, the light (503a) is collimated via the optical component (502) (503b) and broken down into monochromatic partial beams (508a, b, c) with the aid of an optical dispersion component (504) (here, for example, a holographic diffraction grating) according to their wavelengths and converted into a measurable electric current via the detectors (509a, b, c). The dispersion properties of the component (504) must be selected so that the angles of the optical axes (507a, b, c) of the partial beams (508a, b, c) are sufficiently large in relation to each other so that the detectors (509a, b, c) can detect the correspondingly separated partial beams (508a, b, c) exactly and exclusively in each case.

The control and regulation of the light emission of the light source (100) is wavelength-related and is shown in detail in FIG. 3B as “Alternative 1”. Here, after dichroic addition, the light from the light source (100) is focused into the connector (107) with the optics (106) on the one hand and onto the dispersion element (204) as a partial beam (203) with the optical axis (205) on the other hand.

The rest is carried out in a similar way to the measuring device (500), i.e. the spectral-resolved partial beams (208a, b, c) are detected by the detectors (209a, b, c) and are fed back into the light source (100) in a manner related to their wavelength via the controller (23). The “alternative solutions 2 and 3” for controlling and regulating the light emission of the light source (100) are shown schematically in FIG. 3A (300 and 400). 300 is practically identical to 200, except for the reference beam (303a) from the optional “port 4” (34) of the usual “Y” fiber branch (30), now designed as an “X” fiber branch. In the case that 30 is designed as a “multi-mode circulator”, the output power from “Port 4” (34) is usually about 4% of the input power from “Port 1” (32). The actual light emission values are also fed back to the light source (100) in relation to the wavelength via a controller (23), as shown in FIG. 3B. In the event that “Alternative 3” (400, FIG. 3A) is used to control and regulate the light source (100), the properties of the focused light (16) after the wedge-shaped beam splitter (15) must be taken into account. Care must therefore be taken to ensure that the optical axis (17) is offset and slightly tilted relative to the optical axis (805). In addition, the foci of the monochromatic light sources that make up the light source (100) are distributed along the optical axis (17) between the maximum reachable surfaces (21 and 22), in much the same way as the foci of the monochromatic light sources are distributed along the optical axis (14) between surfaces (11 and 12). A sufficiently large aperture (408) is outlined for the wavelength-related detection of the radiation (16), whereby the entire radiation is guided to a detection unit (such as 200 or 300) not shown, whereupon a controller (similar to 23) is used to feed it back into the light source for regulation.

The light that is backscattered or partially reflected by the object surface (10) passes backwards via the beam splitter (15) into the color measuring device (600), where it is first collimated (604) by a hyperchromatic lens combination (601, consisting of 601a and 601b) identical to 801 in order to be detected by the actual color measuring unit (606). Due to the wedge-shaped beam splitter (15), the optical axis (605) of the color measuring device (600) is slightly offset and tilted relative to the optical axis (14). Two different embodiments of the color measuring device (600) are also shown schematically in FIG. 14.

### Description in the Area of Wavelength Selection and Calculation of the Sensor Characteristic Curve

In order to calculate the distance from the two or more independent signal sources of the sensor, a monotonic function must be calculated from the available signal sources. This greatly simplifies the calibration of the system.

Alternatively, since all signal sources deliver measurable signals at the same time, i.e. signals that clearly emerge from the noise, the detected signal pairs can be assigned to the currently set measurement distance in tabular form, whereby the required calibration also takes place simultaneously. This method does not require any further details.

If two bell curves do not overlap, it is practically impossible to determine a continuous sensor characteristic curve from the measurement data. This is the reason why standard chromatic confocal distance measurement, which uses chromatic lenses with a high NA, cannot use laser diodes as a light source (see FIG. 1). In the event that there is a partial overlap of the bell curves, the sensor characteristic curve is calculated according to a very well-known formula of the type

$$\frac{A - B}{A + B}$$

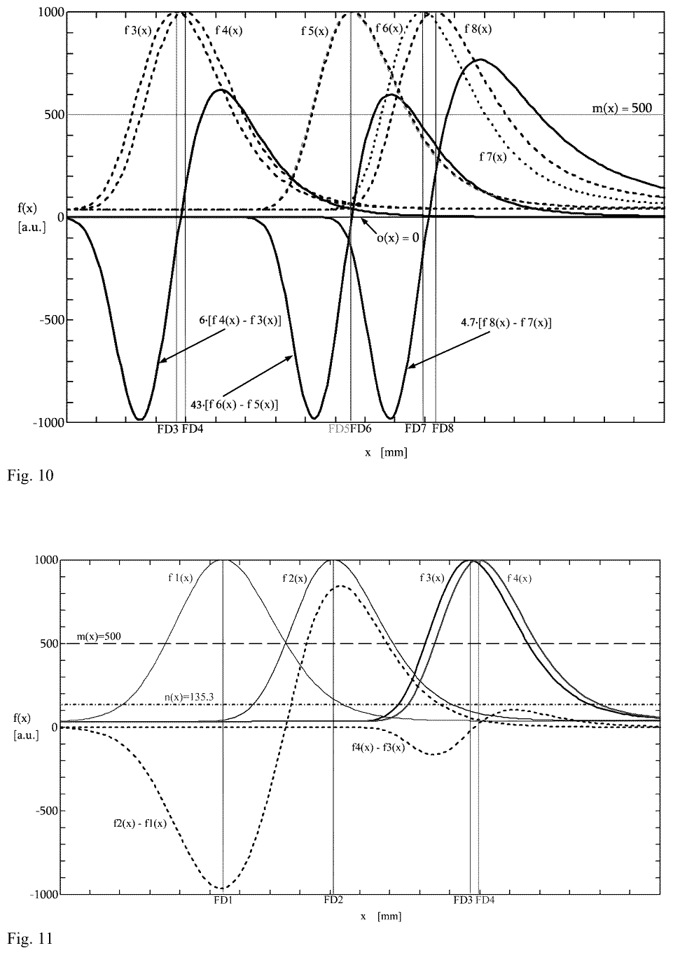

also known as the “contrast function” and which was already described in DE 10 2008 029 459 B4, whereby the signals A and B had to be determined one after the other and stored in the meantime. This type of signal processing also remains important in the present application because it is very robust and scales the information-carrying (A-B) operation with the sum of the signals, so that, for example, influences of changes in the reflective properties of the object can be scaled away. Such a contrast-function formula offers an evaluable characteristic curve only between the peak values of the bell curves, whereby the non-linearity of the characteristic curve and thus the measurement uncertainties increase in the area of the maximum of the bell curves. For this reason, a sensor characteristic curve based solely on this principle and consisting of several (more than two) bell curves could not offer an no uninterrupted distance measurement of the same resolution between the foci of the edge wavelengths in the distance measurement range. This type of evaluation is generally known and is therefore only claimed here in connection with and as a supplement to the calculation of the overall characteristic curve of the sensor using the vector addition method. Furthermore, it is easy to understand that the use of two closely neighboring wavelengths cannot lead to a steeper sensor characteristic curve, because the resulting signal is very small due to the subtraction of two almost identical bell curves and the steepness of the characteristic curve is not influenced by this (see FIGS. 9 and 10).

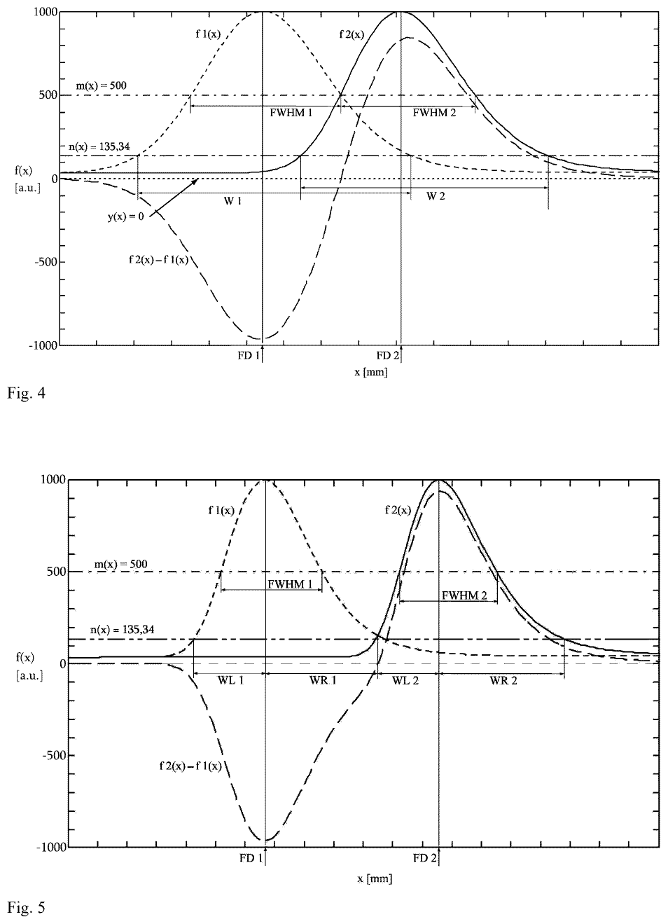

A comparison with the use of monochromatic light sources (laser diodes) together with optical devices according to the SoA CCM measurement technology (see FIG. 1) clearly shows that no practically usable sensor characteristic curve can be determined in such a case. In contrast, FIG. 2 shows that the new measurement method ensures that a sufficient overlap of neighboring bell curves can be achieved. The bell curves are “right-skewed bell curves” due to the wavelength, i.e. the half of the bell curve to the right of the maximum is wider than the left one (see FIG. 5, WR1>WL1, or WR2>WL2). In order to ensure an overlap in the sense of the new measuring method, the laser diodes of two neighboring wavelengths must be selected according to the invention in such a way that the corresponding back-reflection bell curves intersect at an intensity value that is greater than 1/e²=0.1353353 of the intensity maximum (see FIG. 5). In this figure, this limiting case of the bell curve intersection at 1/e² is shown, whereby the two curves f1(x) and f2(x) shown represent measurement data where the wavelength difference is 70 nm. In direct comparison with FIG. 4, the difference between the two curves f2(x)−f1(x) is more non-linear.

Only two bell curves offer a limited possibility of distance measurement, practically between the foci of the two wavelengths (“FD1” and “FD2” in FIGS. 4 and 5). FIGS. 9 and 10 show that excessive overlapping of two neighboring bell curves is rather unfavorable, as the resulting characteristic curve, e.g., by calculating a “contrast function”, provides a very low signal amplitude, as the overlapping bell curves “annihilate” each other. Therefore, the optimum distance between two neighboring wavelengths is preferably defined in such a way that the corresponding back-reflection bell curves intersect at 50% of the maximum intensity of the scaled bell curve (see FIG. 4). In this figure, the two curves f1(x) and f2(x) shown represent measurement data with a wavelength difference of 45 nm. Such bell curves are usually described by their width at 50% of the maximum amplitude (“FWHM 1” and “FWHM 2” in FIGS. 4 and 5).

It should be noted that the longitudinal chromatic aberration of the lens is non-linear and therefore the wavelength differences from FIGS. 4 and 5 are not the same for every usable wavelength. For example, the tested lens has a usable longitudinal chromatic aberration between 350 nm and 980 nm, of which only approx. 30% is used here in order to minimize the number of laser diodes and thus the cost. According to the invention, the desired distance measuring range of the sensor can be determined from the chromatic characteristic curve of the lens and the smallest and largest required wavelengths can be taken from the ends of the distance measuring range. The intermediate wavelength range must be covered with individual laser diode wavelengths in such a way that the resulting back-reflection bell curves of neighboring wavelengths each intersect between 1/e² and 50% of the scaled maximum intensity.

FIG. 9: Measured bell curves, such as f1(x) and f2(x), which are in the amplitude range between n(x)=13.53% (I₀) and m(x)=50% (I₀) the scaled peak amplitude I₀ (approx. 1000 a.u.), are considered to be bell curves with the optimum wavelength, according to the selection procedure of neighboring wavelengths of the laser diodes proposed here. A small non-linearity of the bell curve difference between the two focal lengths s(x)=f2(x)−f1(x) between the two focal lengths FD1 respectively FD2 can be determined.

Here the wavelength difference is 70 nm, but this value depends on the wavelength, as the hyperchromatic lens characteristic curve does not depend linearly on the wavelength. This FIG. also shows the comparison of the function s(x) with the “contrast function” r(x) between the two measured bell curves. It can be seen from this that the use of the “contrast function” increases the measurement resolution locally, but reduces the practically analyzable measurement range between the maxima of the two bell curves. In other words: the contrast function provides the steepest characteristic curve and therefore the highest resolution in the measurement range.

FIG. 10: This FIG. shows graphically that the steepness of the “difference function” of two neighboring bell curves is largely independent of the difference between the corresponding neighboring wavelengths and that the smaller the wavelength difference, the smaller the amplitude of the difference function and thus the possibility of an evaluation. The wavelength difference for f4(x)−f3(x), f6(x)−f5(x) and f8(x)−f7(x) is 5 nm, 1 nm and 30 nm respectively. In order to scale the negative peaks of the difference curves to the same value of approx. −1000 a.u., the difference had to be multiplied by the factor 6, 43 or 4.7. The function o(x)=0 was only used here for orientation as a zero line in the diagram. The function m(x)=500 was also used for orientation, as in other diagrams.

FIG. 11: Due to the small distance between the foci FD3 and FD4, the two corresponding bell curves are almost identical and their subtraction generates a very small signal (in the diagram f4(x)−f3(x)), whereby between the wavelengths λ3 and λ4, 5 nm; the bell curves around FD1 and FD2, which have an optimum distance to each other, serve as a comparison, whereby there is a difference of 45 nm between the wavelengths λ1 and λ2. In principle, this diagram is almost identical to FIG. 10, whereby the normalization factor of the bell curve difference was not used here in order to show the real amplitude difference of f2(x)−f1(x) and f4(x)−f3(x). FDi are here, as in other diagrams, the corresponding focal lengths of the lens for the wavelengths λ1 to λ4. The functions m(x)=500 and n(x)=135.3 were used for orientation with reference to the description.

In the present application, regardless of whether the light sources are operated in pulsed or continuously powered mode, the bell curves are available simultaneously, which is of course advantageous, because the maximum response speed of the sensor is only dependent on the response speed of the photodiodes and their amplifiers.

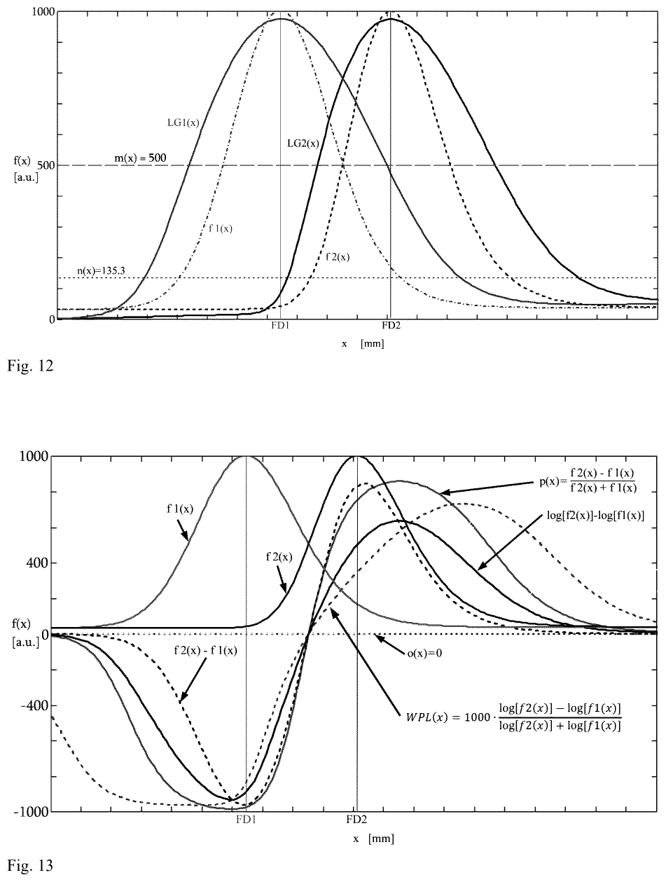

Another possibility for evaluating the sensor characteristic curve is to take the logarithm of the bell curves. In some situations, this may be helpful, because the intersection point of the logarithmized bell curves moves upwards (see FIG. 12) and thus even borderline cases can be evaluated, but the logarithmization also greatly amplifies the noise.

FIG. 12: This FIG. shows the bell curves at λ1 (dotted line) and λ2 (dashed line) are shown as measured curves and their scaled logarithmic conversions as full lines (scaled to approx. 1000 a.u.). The logarithmized bell curves intersect at approx. 80% I₀ instead of approx. 50% I₀ for the linear measurement data, so that an improvement of the sensor characteristic curve is apparently possible. The wavelength difference here is 45 nm. The functions m(x)=500 and n(x)=135.3 were used for orientation with reference to the description.

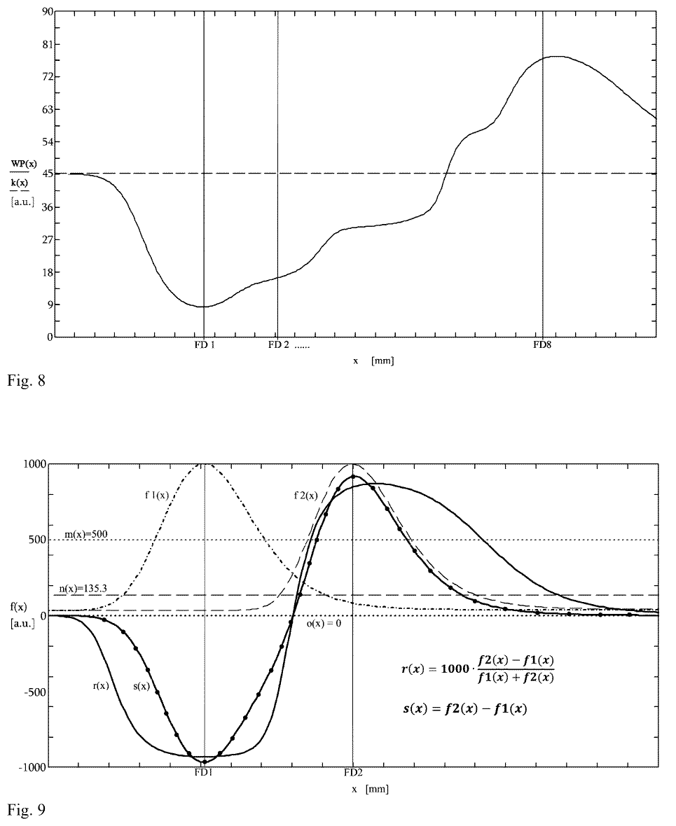

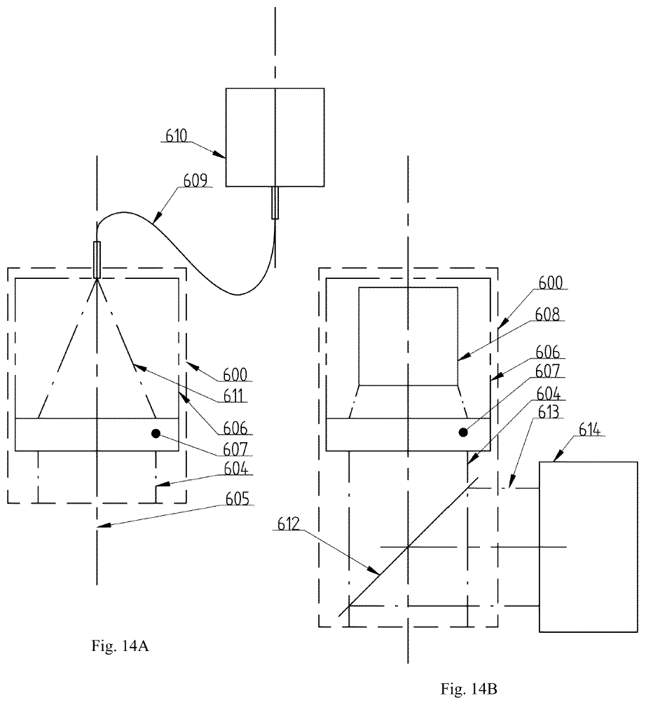

Logarithmization does not offer a higher measurement resolution (see FIG. 13). The contrast function is only used in addition to the overall characteristic curve (FIG. 8) in order to achieve a locally improved resolution between two neighbouring wavelengths. Accordingly, the overall characteristic curve is used according to the “vector addition method” for object detection and the local “contrast function” represents a kind of magnifying glass for a smaller area within the overall characteristic curve.

FIG. 13: In this figure, different calculation formulas (each indicated in the diagram) of two neighboring bell curves are compared in order to show graphically that the “contrast function” p(x) provides the highest resolution of the characteristic curve (steepest characteristic curve). The wavelength difference here is 45 nm, as in FIGS. 11 and 12. The function o(x)=0 was only used here for orientation as a zero line in the diagram.

For SoA CCM, the use of an optical fiber with the smallest possible mode diameter is mandatory, but limited to around 50 μm GRIN fiber, because too little power can be coupled into the fiber from the usual non-coherent polychromatic light source.

In the present invention, laser diodes are used and thus sufficient light power could be coupled even into single-mode (SM) fibers. According to the invention, however, large STIN fiber diameters are used (≥50 μm) in order to ensure that as many transverse oscillation modes as possible can propagate in the fiber, as otherwise the edges of the back-reflection bell curves would be strongly modulated and the calculation of a monotonic sensor characteristic curve would be made more difficult. As the propagation of the transverse oscillation modes is inversely proportional to the wavelength, this also limits the maximum wavelength that can be used. For increased operational reliability of the present invention, so-called “mode scramblers” are also used at various points of the “fiber coupler” (30), which cost a little power but significantly increase the number of transverse oscillation modes. The use of single-mode optical fibers in the present invention is not possible.

### Method for Calculating the Sensor Characteristic Curve

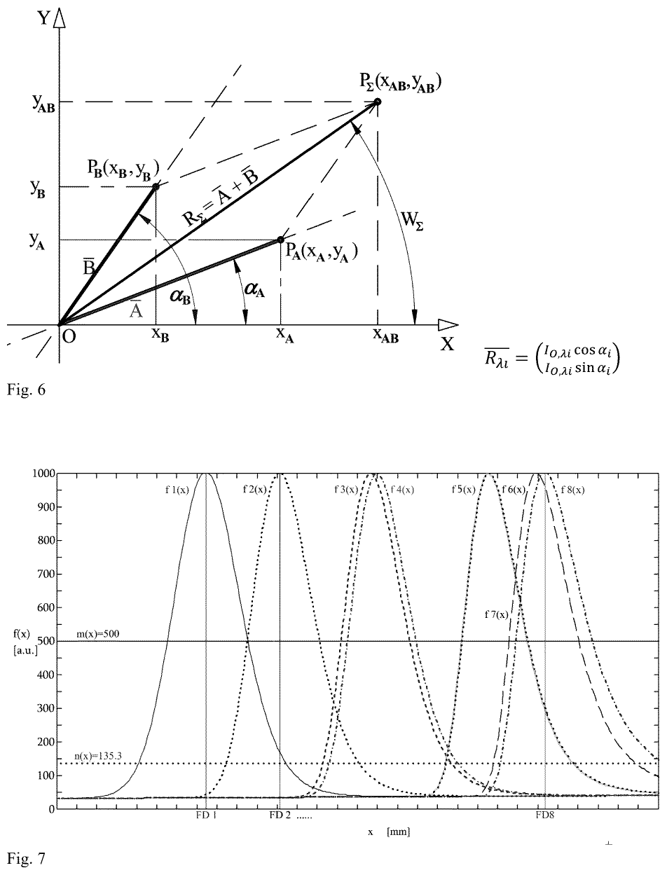

A method for calculating a sensor characteristic curve SK is described with reference to FIGS. 6, 7 and 8. FIG. 6 shows a sketch of the vector addition: Starting from two vectors Ā and B̅, which represent the angles α_{A} and α_{B} with the X-axis, the vector peaks can be described using their coordinates: P_{A}(X_{A}, Y_{A}) and P_{B}(X_{B}, Y_{B}). The sum of the vectors R_{Σ}=Ā+B̅ can be calculated graphically (as in FIG. 6) or analytically, whereby the peak of the vector sum can be described by its coordinates, similar to the individual vectors P_{Σ}(X_{AB}, Y_{AB}). The angle of the vector sum W_{Σ} can be calculated as

$$arc tan \frac{{Y}_{A B}}{{X}_{A B}} .$$

. Vector addition is used in connection with the calculation of a sensor characteristic curve.

FIG. 7 shows the measured typical right-skewed distance-related back-reflection intensity curves (bell curves) as a function of their wavelengths or focal lengths. The intensity curves are scaled to approx. I_{O}≈1000. For each wavelength λᵢ of a monochromatic light source of the sensor light source (100), such a bell curve is created, whereby the smallest focal point of each wavelength is created on the optical axis 14 at the focal length FDi so that the focal distances (“FD”) FD1<FD2< . . . <FD8 correspond to the wavelengths:

$$405 nm = λ 1 < λ2 < … < λ8 = 750 nm .$$

In most diagrams, as in FIG. 7, the levels of m(x)=50%·I_{O}=500 and n(x)=1/e²·I_{O}≈13.3%·I_{O}=135.3 are also displayed. These are used to assess the overlap between two neighbouring bell curves.

The overall sensor characteristic curve shown in FIG. 8 was calculated from the bell curves (FIG. 7). WP(x), which has a non-linear but monotonic curve:

$$WP ( x ) = {W}_{Σ} ( x ) = arctan \frac{{y}_{Σ}}{{x}_{Σ}}$$

where W_{Σ}(x) is the numerical value of the angle of the vector addition. The vectors for this addition each have the maximum value of the corresponding bell curve as their magnitude, and the angle is assigned depending on the wavelength. The greater the number i of wavelengths is, the smoother the sensor characteristic curve WP(x) becomes. The function k(x) corresponds to the asymptotic value of the function WP(x) outside the measuring range.

### Method for Detecting the Color

Due to the wavelength-dependent focusing, the area around the current measuring point on the object surface cannot easily be captured with another instrument, such as a camera for visualization or a conventional color measuring device, because the existing beam path prevents the use of these instruments as defined.

However, it makes sense to solve this problem according to variants of the invention in such a way that the back-reflection from the object surface (10) passes via a partially transparent beam splitter (15) into the measuring module (600, “sensor F”), where it first passes through a chromatic unit (601), which is identical to the chromatic unit 801. This shapes the beam path (604), similar to 804b, so that the object surface (10) can be correctly captured by a camera. According to the invention, the measurement module (600) can be designed in various embodiments, some of which are shown schematically in FIGS. 14A and 14B The use of a fiber-coupled spectral-resolving measuring module (610, practically identical to the measuring module 500) for determining the object surface color is particularly advantageous. For this purpose, the radiation (604) is focused (611) via the matching optics (607), in this case a converging achromat, into the optical fiber (609) and guided over it for analysis in the spectral-resolving measurement module (610). Here, 606 (FIGS. 14A and 14B) generically designates the component that receives the radiation (604) for further processing by the lens (601). The module 610 (FIG. 14A) with the necessary beam shaping (607, 611, 609) is replaced in FIG. 14B by a 2D matrix light intensity detecting module (608). This can be a color camera or an area color sensor in which each pixel is a color sensor (usually for RGB colors). In this case, the matching optics (607) adjusts the diameter of the radiation (604) to the active diameter of module (608).

In general, a beam splitter can be of any design and optionally have anti-reflective coatings and/or surfaces arranged at an angle to the beam path in order to minimize back-reflections and interference with little or no optical offset.

In particular, the beam splitter (15) can be designed as a wedge-shaped beam splitter plate in order to avoid interference effects. However, this results in a beam offset and a beam tilt around the apex angle of the wedge.

In a modification of FIG. 3A, the beam splitter (15) can in principle be mounted between the chromatic unit (801) and the lens (802) in order to eliminate the objective/chromatic unit (601). In the case of a (wedge-shaped) beam splitter plate, however, the construction of the chromatic objective (800) becomes more complicated and additional aberrations occur. A plane-parallel plate could be introduced, but this in turn causes interference. In principle, it is possible to use a beam splitter cube, as this works coaxially and does not cause any beam offset, although the flat surfaces of the beam splitter cube, which are perpendicular to the beam axis, can cause undesirable back-reflections. To avoid this, the beam splitter can be treated with an anti-reflective coating and/or can be slightly tilted (<8°) in order to be mounted between the chromatic unit (801) and the lens (802) and to achieve a more compact design (no drawing provided).

The measurement of object color is more complex and therefore there are a number of certified measurement methods that evaluate different color-dependent key figures, for which there are conversion formulas. The measurement method proposed here is not yet known and certified, as it breaks new ground and is easier to use. According to the invention, the reflectivity of the object surface still has to be determined with module 614 alone or in combination with modules 610 or 608. For most applications, it makes sense for the reflectivity measurement to use light L_{NIR} with a wavelength outside the wavelength range used by the distance sensor λ₁ to λₙ is used. The subscript “NIR” was used here in the sense of near-infra-red light (“NIR”), as a NIR wavelength such as 750 nm is ideal for this. However, other wavelengths can also be used for reflectivity measurement. The light L_{NIR} (no drawing provided) can originate from a light source (in particular a laser diode or SLED or LED), which is located coaxially in module 614. The beam path (613) is created by beam-shaping optics (no drawing provided), which is also accommodated in the module 614. The beam-shaping optics also contain a beam splitter (no drawing provided), which feeds the back-reflection with the wavelength λ_{NIR} to a detector that carries out the reflectivity measurement. The reflectivity measurement can be carried out completely separately from the color measurement in the schematically illustrated module (614), whereby, in this case, it is advantageous to use the beam splitter 612 as a short-pass filter with the step wavelength λ_{KPF} so that λₙ<λ_{KPF}<λ_{NIR}, whereby the radiation 613 only contains wavelengths λ>λ_{KPF} and thus λ_{NIR} passes through.

The reflectivity measurement must necessarily be made through the hyperchromatic objective (601 or 801) in order to be coaxial with the other measurements, but it has its own matching optics (607), which enables it to shape the light L_{NIR} with the wavelength λ_{NIR}>λₙ (whereby λₙ is the largest wavelength used in the system), so that it is collimated, focused or defocused on the object surface. In addition, it is advantageous that the matching optics (607) of the reflectivity measurement (not shown, included in module 614) is designed to be axially movable and lockable, so that the position of the resulting focal point on the optical axis 14 can be adjusted as desired relative to the object surface 10.

If the detection of the back-reflection with the wavelength λ_{NIR} (see FIG. 14A with a spectral-resolving measuring module (610, similar to 500), it must be ensured that the wavelength λ_{NIR} is clearly measured and that the detection takes place without overlapping with other spectral components of the other lights, whereby the beam splitter 612 must allow all wavelengths used to pass through.

In order to be able to use the reflectivity measurement simultaneously with the other measurement methods, they must be separated in such a way that they do not influence each other. The clock frequencies used for reflectivity measurement and distance measurement are so different that they do not correspond to the harmonics of the other measurement. However, there are evaluation methods for signals with different frequencies that coexist in the same system, which benefit from synchronizing the signals. In this case, the frequencies must be selected so that the beat frequency from the convolution of both frequencies is very different from the measured topography measurement frequency. A simpler situation arises if the distance measurement is carried out in continuous-wave mode with a clock frequency of zero, in which case the reflectivity measurement can be operated with any frequency.

In the general description, module 600 (“Sensor F”) was initially described as a color sensor or as a camera for visualizing the object surface. Of course, it is always possible to integrate a camera in this area using its own beam splitter and matching optics. This is regarded as an easily recognizable extension of the optical system and is therefore discussed without a more detailed explanation and without drawings.

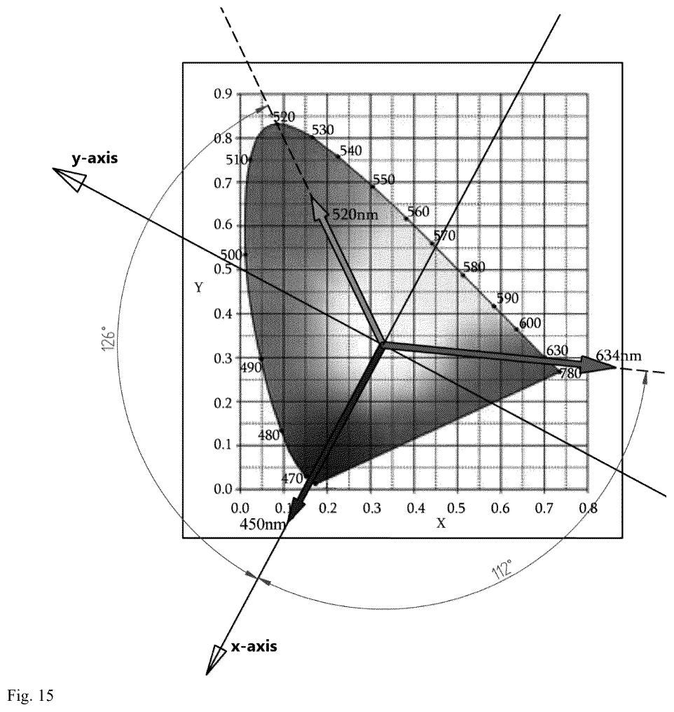

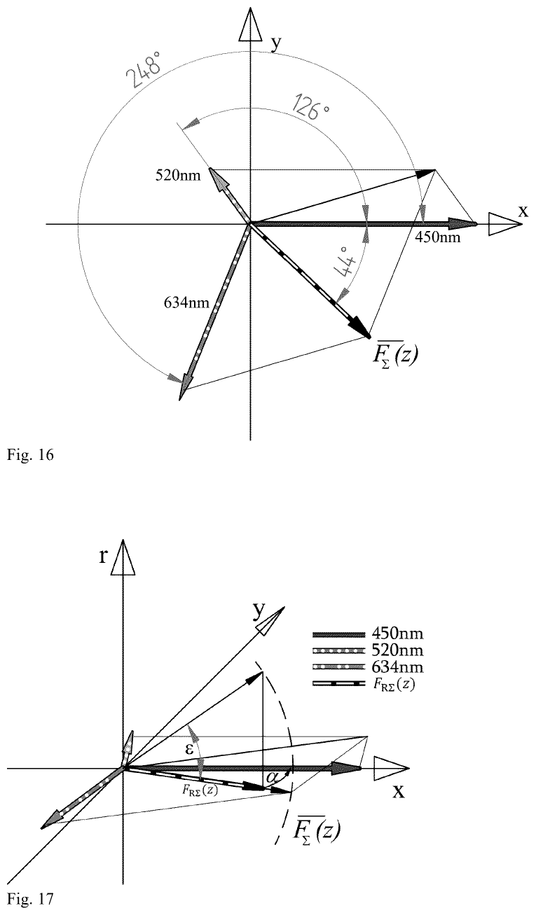

The following steps are used to analyze color information:
1. In the CIE “color triangle”, also known as the “shoe sole diagram”, a Cartesian XY coordinate system is superimposed in such a way that the origin of the axis lies in the white center (at the CIE coordinates (x=approx. 0.33, y=approx. 0.33)) (see FIG. 15), although in principle a different color diagram can also be used;
2. The X-axis of the new coordinate system connects the origin of the axis with the point at the edge of the shoe sole diagram that corresponds to the smallest laser wavelength used in the sensor (e.g., λ₁=450 nm, see FIG. 15). This value is also assigned the angle β₁=0° is also assigned to this value. The Y-axis is clockwise at β=90°;
3. According to the other wavelengths used in the sensor: λ₂=520 nm, λ₃=634 nm, the corresponding points are connected from the edge of the shoe sole diagram to the origin of the axis; this results in the angles: β₂=126°, β₃=248°, which represent the angles of the “color vectors” [symbol] , which each have the value J_{λi}=Jᵢ=gemessene Intensität der Farbe λᵢ. FIG. 16 shows the XY coordinate system in the usual form—this also makes it clear why the angles in this section, or in FIG. 15, have positive values. In FIG. 16, the angles are measured “correctly”, with positive values, in counter-clockwise direction;
4. The color vectors [symbol] are added together and produce a resulting vector that is set in relation to the measured distance z: [symbol] (z). The angle β_{Σ}=44° results from the example shown in FIG. 16, but otherwise it depends on the wavelengths used and the actually measured color intensities J_{λi}=Jᵢ; and
5. For a correct measurement of the color, the measured reflectivity at the distance z just measured must also be taken into account R(z) (see FIG. 17). The reflectivity is shown schematically in a 3D coordinate system xyr in this figure. According to the reflectivity measured, the vector determined in 4, [symbol] (z), from the XY plane is rotated upwards by the angle

$$ε = arctan \frac{R ( z )}{{\sum }_{i = 1}^{n} \vert {\overline{F}}_{i} \vert} .$$

The projection of the rotated vector onto the XY plane lies on the vector [symbol] (z) and has the shortened value F_{RΣ}(z) and represents the “color measurement result”. The angle α with the X axis lies in the XY plane.

### Alternative Use of the New Measuring Method

The new tandem measurement method presented (simultaneous distance and color measurement) is fast enough to perform most known real-time measurement tasks, e.g., in production lines. However, this leads to a topographical detection along a line given by the production flow or by the robot arm (or gantry system) that holds and moves the sensor.

However, in many applications of this type, 2D topography is preferred for two reasons: a) the small measurement spot size makes it difficult to position the sensor on the object feature of interest, and b) the accuracy of robotic and gantry systems is usually worse than the accuracy of the proposed new sensor, and thus any additional axis that would move the sensor across the production flow could generate additional measurement errors. For these reasons, two alternative scanning methods are presented here that incorporate the new sensor unchanged and significantly expand the range of potential applications.

Typically, the known scanners contain one or more components that are moved mechanically (widely used are galvanometer scanners and resonance scanners, which basically perform an oscillating back-and-forth motion around a pivot point). Such devices can only be operated at relatively low frequencies (a few hundred Hz), as they always have to overcome their own mechanical inertia at the turning points of the oscillating movement, whereby at these points the moving components (e.g., mirrors) generate additional aberrations due to their own mechanical deformation under the influence of the reversal forces.

The scanner functioning principles presented here are new mainly due to the combination with the new measuring process and because they optimally support the properties and specifications of the new sensor. Thus, in both proposed set-ups, the moving components are rotated continuously, so that no overcoming of mechanical inertia is required and the precise control of the revolution speeds enables a much higher accuracy of the movement.

Another common feature of the two scanners presented here is the small NA of the sensor, which does not allow large deflection angles of the measuring beam through the scanners—both are so-called “telecentric” scanners, in which the beam path moving through the scanner remains parallel to itself during the entire movement. This means that the maximum permissible tilt angle of the object surface of the sensor alone is also maintained for the scanner.

### Variant 1: Telecentric Circle Scanner

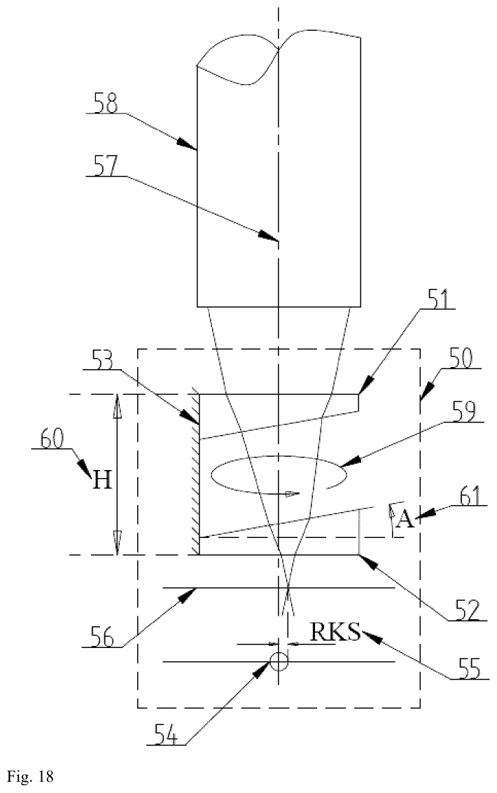

FIG. 18 shows the telecentric circular scanner (50) as a sketch. It consists of two round wedge-shaped prisms (51 and 52), which have the same apex angle “A” (61) and are rigidly coupled to each other via a cylindrical holder (53) in such a way that the tilted surfaces of the prisms (51 and 52) are exactly parallel to each other. The entire prism package (51-53) is mounted rotatably around the optical axis (57) of the sensor and can be rotated around the optical axis (57) of the sensor in a precisely controlled manner using any type of drive. The entire prism package is mounted between the distance sensor, indicated here by (58), and the measurement object surface (56).

When the light from the distance sensor (58) focused on the surface of the object being measured (56) passes the first prism (51), it is deflected according to the apex angle “A” (61). This drastically reduces the beam quality and tilts the optical axis. Due to the exactly parallel alignment of the apex surface of the second prism (52), which is identical to (51), all aberrations introduced and the tilting of the optical axis are completely compensated. The focal point of the sensor (58) is offset by the prism package at a distance “RKS” (55) from the optical axis (57) of the sensor. The rotational movement (59) of the prism package (51-53) creates a circular path (54) on the surface (56) of the object being measured. Changes to the distance “H” (60) between the two prisms set the desired radius of the circular path “RKS” (55). If the two apex surfaces lie exactly on top of each other, RKS=0. Furthermore, the maximum value of the circular path radius “RKS” (55) can be influenced by the apex angle “A” (61) and by the appropriate selection of the refractive index n_{TKS} of the prisms. During the rotational movement (59), the optical axis of the light striking the object remains parallel to the optical axis (57) of the sensor.

In order to further improve the topography measurement along the circular path (54), it is necessary according to the invention to tilt the rotation axis of the prism package (51-53) with respect to the optical axis of the sensor by a small angle <8° in order to avoid direct reflections from the flat surfaces of the wedge-shaped prisms (51 and 52).

### Variant 2: Telecentric Line Scanner

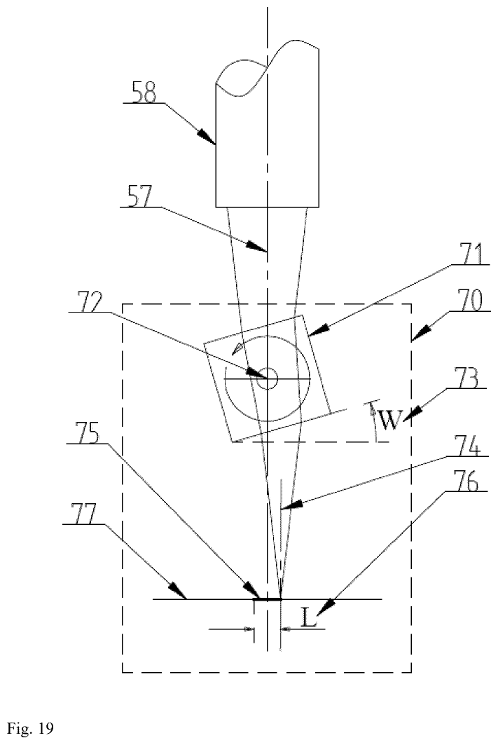

FIG. 19 shows the telecentric line scanner (70) as a sketch. It consists of a cube-shaped prism (71), which is mounted for rotation about the axis (72) (perpendicular to the drawing plane and to the optical axis of the sensor (5)). The prism can be rotated about its axis (72) in a precisely controlled manner using any type of drive. The rotatable prism is mounted between the distance sensor, indicated here by (58), and the object surface (77).

When the light from the distance sensor (58) focused on the object surface passes the prism (71), it is deflected according to the angle of rotation “W” (73). As the exit surface of the prism is parallel to the entry surface, the beam quality is not degraded and after the light has exited, the optical axis (74) remains parallel to the optical axis (57) of the sensor. The focal point of the sensor (58) is offset at a distance “L/2” (76) from the optical axis (57) of the sensor by the rotation of the prism. The rotary movement of the prism thus creates a linear path (75) on the object surface (77). Changes in the side length of the prism lead to corresponding changes in the scan length “L” (75). The scan length can also be influenced by changes in the refractive index of the prism n_{TLS}. According to simulations, the optical surfaces of the prism (71) can be treated with anti-reflective coating in accordance with the invention in order to be able to utilize the largest possible angle of rotation of the prism when the refractive index is n_{TLS}>1.65. In the same context, for a refractive index n_{TLS}<1.65 it is better not to have the anti-reflective coating.

Due to the shape of the cube prism (71), four line measurements of the object topography are made per rotation of the cube prism (71). The edges of the cube prism (71) should be blackened in order to be able to sharply delimit the ends of the scan line “L” (75) before the measurement signal intensity decreases too much. During the rotation of the cube prism, the focal point of the sensor (58) moves along a “slight” hyperbolic path in the plane formed by the optical axis (57) and the imaginary scan line (75), with the maximum of the hyperbola at the point of intersection with the optical axis (57). The term “slight” hyperbolic path was used because the deviation of the actual path from a straight line is small and much smaller than the height measurement range of the sensor (58), so this deviation can be compensated for a straight object surface by a corresponding calibration. In order to further improve the topography measurement along the line “L” (75), it is necessary according to the invention to tilt the axis of rotation (72) of the cube prism (71) relative to the optical axis of the sensor by a small angle <8° in order to avoid direct reflections from the cube surfaces.

### LIST OF REFERENCE SIGNS

10 Surface of the object being measured
11 Focal plane of the longest wavelength used (red)
12 Focal plane of the shortest wavelength used (blue)
13 “Chromatic” beam path according to beam splitter (15)
14 Optical axis of the measurement on the object
15 Wedge-shaped, AR-coated (e.g., R:T=90:10) beam splitter
16 “Chromatic” beam path for alternative 3_Ref. measurement (400)
17 Optical axis of the beam splitter for alternative 3_Ref. measurement (400)
18 Angle between lens-1_OA (805) and 14 (90°)
19 Angle between lens-1_OA (805) and lens-2_OA (605) (90.5°)
21 Focal plane longest wavelength (red) Alternative 3_Ref. measurement (400) (*)
22 Focal plane shortest wavelength (blue) Alternative 3_Ref. measurement (400) (*) (*) If no optical components (lenses, filters etc.) are mounted in the way
23 Wavelength-related regulator and controller of light source emission
30 “Y” fiber coupler or MM “Y” circulator
31 “Port 2”/output fiber “Y” coupler to the “chromatic” lens (800)
32 “Port 1”/input fiber “Y” coupler from the laser diode module (100)
33 “Port 3”/output fiber “Y” coupler to the measuring module (500)
34 “Port 4”/Optional Y-coupler output for alternative 2_Ref. measurement (300)
35 FC/APC fiber connector for chromatic lens #1 (800)
36 FC/PC fiber connector for RGB laser diode module (100)
37 FC/PC fiber connector to the measurement module (500)
38 FC/PC fiber connector to Ref. 2_measurement module (300)
50 Telecentric circle scanner
51 Round wedge-shaped prism with apex angle “A” (51) and refractive index n_{TKS}
52 Round wedge-shaped prism with apex angle “A” (51) and refractive index n_{TKS}
53 Rigid coupling of the prisms (51 and 52) mounted rotatably around the optical axis (57)
54 Top view of the circular path (radius “RKS”=55) of the focal point of the chromatic confocal distance sensor (58)
55 Radius “RKS” of the scanner path on the object surface
56 Surface of the object being measured
57 Optical axis of the chromatic confocal distance sensor (58)
58 Chromatic confocal distance sensor
59 Indicated rotation of the two rigidly coupled prisms (51 and 52)
60 Distance “H” between the two rigidly coupled prisms (51 and 52)
61 Apex angle “A” of the two rigidly coupled prisms (51 and 52)
70 Telecentric line scanner
71 Cube-shaped prism made of glass with refractive index n_{TLS}
72 Axis of rotation of prism (71), shown vertically
73 Angle of rotation of the prism (71) around the axis (72)
74 Optical axis in the measuring point parallel with (57)
75 Path of the focal point on the object surface (77) while (71) rotates
76 Length “L” of the focal point path on the object surface (77)
77 Surface of the object being measured
100 RGB laser module/light source
101a, b, c RGB laser diodes
102a, b, c Collimating lenses for RGB laser diodes
103 Dichroic mirror
104 Dichroic mirror
105 Dichroic mirror
106 Achromat for beam focusing into the fiber (32)
107 Fiber connector socket for holding (36)
110 Output light beam of the RGB module (100)
200 Alternative 1, reference measurement for laser diode feedback (FIG. 3B)
201 Fiber connector socket for FC/PC fiber connector
202 Collimating lens, achromat
203a, b Beam path in front of the grating (204)
204 Dispersion element, e.g., holographic diffraction grating
205 Optical axis of the beam path (203)
206 Normal on the diffraction grating
207a, b, c Optic axes of the diffraction beams
208a, b, c Diffraction beams according to the wavelengths used
209a, b, c Photodetectors, preferably PIN photodiodes
210a, b, c Transimpedance amplifier
211a, b, c Outputs of the transimpedance amplifier (210)
300 Alternative 2, reference measurement for laser diode feedback
301 Fiber connector socket for FC/PC fiber connector
302 Collimating lens, achromat
303a, b Beam path in front of the grating (304)
304 Dispersion element, e.g., holographic diffraction grating
305 Optical axis of the beam path (303)
306 Normal on the diffraction grating
307a, b, c Optic axes of the diffraction beams
308a, b, c Diffraction beams according to the wavelengths used
309a, b, c Photodetectors, preferably PIN photodiodes
400 Alternative 3, reference measurement for laser diode feedback
408 Aperture for light detection
500 Distance measuring module (light power measuring device)
501 Fiber connector socket for FC/PC fiber connector
502 Collimating lens, achromat
503a, b Beam path in front of the grating (504)
504 Dispersion element, e.g., holographic diffraction grating
505 Optical axis of the beam path (503)
506 Normal on the diffraction grating
507a, b, c Optic axes of the diffraction beams
508a, b, c Diffraction beams according to the wavelengths used
509a, b, c Photodetectors, preferably PIN photodiodes
600 Chromatic lens “color” and color measurement
601 Chromatic unit (hyperchromat) #2
601a Convergent lens #2
601b Divergent lens #2
604 Beam path according to chromatic unit #2 (601)
605 Optical axis of chromatic unit #2 (601)
606 Color measuring device or camera
607 Fitting optics
608 2D array sensor (CCD camera or consisting of color measuring points)
609 Optical multi-mode STIN fiber as connection (606 with 610)
610 Spectral-resolving measuring module (practically identical to 500)
611 Beam path (604) focused on the entry window of the fiber (609)
612 Beam splitter: >90% transparent for 604 and >90% reflective for 613
613 Beam path of the reflectivity measurement for λ_{NIR}>λₙ=largest wavelength
614 Light source and beam shaping for reflectivity measurement with λ_{NIR}
800 Chromatic lens “distance” and distance measurement
801 Chromatic unit (hyperchromat) #1
801a Convergent lens #1
801b Divergent lens #1
802 Collimator lens, achromat
803 FC/APC-Fiber connector socket
804a, b Beam path within the lens #1 (800)
805 Optical axis of chromatic lens #1

What is claimed is:

1. A distance measuring method using the principle of chromatic confocal distance measurement, emitting light with a polychromatic light source comprising a plurality of single-mode or multi-mode, pulsed or continuously powered laser diodes, focusing the light thus obtained into a multi-mode “Y”- or “X”-shaped splice fiber coupler with a fiber core diameter of at least 50 μm, preferably designed as a “multi-mode circulator”, wherein an output fiber of the fiber coupler is introduced into a chromatic objective via an FC/APC fiber connector, and focusing the wavelengths of the light of the light source into distinct focal points on the optical axis at different distances according to a longitudinal chromatic aberration characteristic curve of the objective such that a resulting back-reflection from an optical, at least partially reflective, surface of the object is measured, which lies at 90°±arctan(NA), approximately perpendicular to the optical axis between the foci of the shortest and longest laser diode wavelengths used, the back-reflection returns into the fiber coupler via the chromatic objective and is fed via a measurement output fiber of the fiber coupler to a spectral-resolving light power measuring device, which measures each of the monochromatic wavelengths used separately.

2. A method for selecting the suitable laser diodes or their wavelengths for implementing the chromatic confocal distance measurement method according to claim 1,
wherein a sensor includes the polychromatic light source, the fiber coupler, the fiber connector, the chromatic lens and at least one photodiode,
wherein the sensor detects the confocal back-reflection for each laser diode wavelength with the form of a right-skewed intensity distribution over the optical axis of the sensor and with the maximum value in the coaxial focus of the sensor for the selected wavelength, wherein the smallest and the largest wavelengths are selected such that a desired distance measurement range lies between the foci of the smallest and largest wavelengths in accordance with the chromatic characteristic curve of the objective, and, for gapless measurement of the distance within the distance measurement range, selecting a minimum number of additional laser diodes, whose emission wavelengths lie between the smallest and largest selected wavelengths, such that resulting back-reflection bell curves of two neighboring wavelengths intersect in each case at an intensity value which is greater than 1/e²=0.13533 of an intensity maximum of one of these wavelengths.

3. The method according to claim 1, wherein the procedure is carried out as part of an interferometric measurement procedure.

4. A method for determining a monotonic sensor characteristic curve from measurement signals at different distances from a surface of an object being measured, whereby the sensor characteristic curve being used for calibration for the distance measurement method according to claim 1, the method including: assigning a vector [symbol] to each measurement signal with wavelength λᵢ such that the vector magnitude corresponds to the measurement signal magnitude I_{λi}=Iᵢ and the vector angle α_{λi}=αᵢ to a horizontal axis in a Cartesian coordinate system corresponds to a value that is assigned according to the wavelength such that the smallest wavelength λ₁ is in particular α₁=0°, the largest wavelength λₙ is in particular αₙ=90° and the other wavelengths between angles α₂ to αₙ₋₁ corresponding to a numerical ratio of the wavelengths, whereby for the calculation of a monotonic sensor characteristic curve over the entire working measuring range between the foci of the smallest and largest wavelengths used, the vectors [symbol] are added up vectorially and the angle W_{Σ}(z) of the resulting vector [symbol] is used as or for the z-dependent sensor characteristic curve, where the angle of the resulting vector is
$${W}_{Σ} ( z ) = arctan \frac{{y}_{Σ}}{{x}_{Σ}}$$
and where z is the axial measurement coordinate, y_{Σ}=Σᵢ₌₁ⁿ Iᵢ sin αᵢ, x_{Σ}=Σᵢ₌₁ⁿ Iᵢ cos αᵢ.

5. The method according to claim 4, wherein the angle W_{Σ}(z) for linearization is scaled by the magnitude of resulting vector
$${B}_{Σ} ( z ) = \sqrt{{x}_{Σ}^{2} + {y}_{Σ}^{2}}$$
and designated by
$${S}_{Σ} ( z ) = \frac{{W}_{Σ} ( z )}{{B}_{Σ} ( z )}$$
where S_{Σ}(z) is used as the z-dependent sensor characteristic curve.

6. The method according to claim 1, wherein the objective is designed with a numerical aperture NA<0.2 and a ratio of the longitudinal chromatic aberration to a focal length of the objective for the shortest used wavelength of 0.15 to 0.5.

7. The method according to claim 6, wherein the objective consists either of an achromatic collimating lens and a coaxially mounted hyperchromatic combination of two spatially separated optical components or only one of such a hyperchromatic combination of optical components.

8. The method according to claim 7, wherein the hyperchromatic combination consists of two optical, coaxially and spatially separated components, wherein the components are either two refractive, or one refractive and one diffractive optical component.

9. The method according to claim 1, wherein a broadband beam splitter is used in the beam path between the objective and the surface of the object being measured or between the lens and the chromatic unit for the simultaneous detection of an object color, wherein the broadband beam splitter deflects a part of the light reflected by the surface of the object being measured in the direction of a color measuring device.

10. The method according to claim 9, wherein the beam splitter is a wedge-shaped beam splitter, with a wedge angle of substantially 0.5°, in order to avoid at least one of reflections or etalon effects.

11. The method according to claim 1, further including: feeding the light reflected back from the surface of the object being measured, without passing through a limiting aperture, to a spectral-resolving measuring device which supplies an intensity signal to a higher-level signal evaluation unit for each wavelength used.

12. The method according to claim 2, wherein, for the evaluation of a detected color information, a vector F̅ᵢ is assigned to each measurement signal with the wavelength λᵢ such that the vector magnitude corresponds to the measurement signal magnitude J_{λi}=Jᵢ and that the vector angle β_{λi}=βᵢ to a horizontal axis in a Cartesian coordinate system corresponds to a value that is assigned according to the wavelength such that a first vector angle β₁ is assigned to the smallest wavelength λ₁ and the angles β₂ to βₙ are assigned to the remaining wavelengths λ₂ . . . λₙ according to wavelength specifications on the edge of the color diagram, whereby a zero of the Cartesian 2D coordinate system lies in a white, achromatic center of the color diagram, and that the vectors F̅ᵢ are vectorially added up to form a resulting z-dependent vector [symbol] (z), which is then used for the consideration of the recorded object reflectivity R(z), with its origin in the origin of the XY Cartesian coordinate system tilted from the XY plane by the angle
$$ε = arctan \frac{R ( z )}{{\sum }_{i = 1}^{n} \vert {\overline{F}}_{i} \vert}$$
and the color measurement result is F_{RΣ}(z) the length of the distance from the origin of the Cartesian coordinate system to the projection of the tip of the tilted vector [symbol] (z) onto the XY plane, where z is the axial measurement coordinate of the object surface and α is the angle of the resulting vector with the x-axis.

13. The method according to claim 12, wherein the color diagram is a shoe sole color diagram and wherein β₁=0° applies to the smallest wavelength used.

14. The method according to claim 12, wherein the z-dependent “Sensor F” color measurement result F_{RΣ}(z) for linearization with the geometric sum of the spectral vector magnitudes
$${BF}_{Σ} ( z ) = \sqrt{{\sum }_{i = 1}^{n} {\vert {\overline{F}}_{i} \vert}^{2}}$$
is scaled and designated by
$${SF}_{Σ} ( z ) = \frac{{F}_{R Σ} ( z )}{{BF}_{Σ} ( z )}$$
where SF_{Σ}(z) is used to evaluate the detected color information.

15. The method according to claim 12, wherein, in the case of objects with a surface which reflects the light in different diffuse to specular ways, a further light L_{NIR} outside a visible wavelength range is reflected into the beam path around the optical axis in such a way that the further light L_{NIR} strikes the surface of the object being measured around the measurement point.

16. The method according to claim 15, wherein the additional light L_{NIR} is also detected wavelength-dependent in the color measuring device (606) and wherein the measured intensity J_{NIR} corresponding to the surface reflectivity of the object is used to correct and calibrate the color measurement result F_{RΣ}(z); and
wherein the further light L_{NIR} strikes the surface of the object being measured in a collimated manner.

17. A sensor configured to carry out the method according to claim 2, wherein the sensor includes the polychromatic light source, the fiber coupler, the fiber connector, the chromatic lens and at least the photodiode.
